(19) United States
(12) Patent Application Publication
(10) Pub. No.: US 2009/0157407 A1
(43) Pub. Date: Jun. 18, 2009

(54) Methods, Apparatuses, and Computer Program Products for Semantic Media Conversion From Source Files to Audio/Video Files

(75) Inventors: Tetsuo Yamabe, Saitama (JP); Kiyotaka Takahashi, Saitama (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/954,505

(22) Filed: Dec. 12, 2007

(51) Int. Cl. G10L 13/08

(52) U.S. Cl. 704/260; 704/E13.005

(57) ABSTRACT

An apparatus for semantic media conversion from source data to audio/video data may include a processor. The processor may be configured to parse source data having text and one or more tags and create a semantic structure model representative of the source data, and generate audio data comprising at least one of speech converted from parsed text of the source data contained in the semantic structure model and applied audio effects. Corresponding methods and computer program products are also provided.

### TECHNOLOGICAL FIELD

Embodiments of the present invention relate generally to mobile communication technology and, more particularly, relate to methods, apparatuses, and computer program products for converting source data, such as web files, to video or audio data.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

This explosive growth of communications networks has allowed several new media delivery channels to develop, including channels allowing for the distribution of content generated by individual consumers. Current and future developments in networking technologies continue to facilitate ease of media content delivery and convenience to users. However, one area in which there is a demand to further improve the ease of media content delivery and convenience to users involves improving the ability to deliver media content over multiple kinds of media delivery channels with minimum user effort.

Popular Internet services now allow even users who are not technologically savvy to create and distribute their own media content. The popular website YouTube, for example, allows users to publicly post and distribute for public viewing their own video files, which they may have filmed using commonly available portable electronic devices, such as digital cameras or camera-equipped mobile phones and PDAs, or may have created through animation software. Online sites such as Live Journal and Blogger and user-friendly server-side software such as Word Press and Moveable Type allow users to easily post written opinions or accounts of experiences, known as “web logs” or just “blogs”. Users may even easily create and distribute digital audio files containing audio content that they have created. These user-created audio files may then be distributed in formats such as “podcasts” for playback on portable media players.

The improvement in mobile networking technology as well as improvements in the capabilities and continued size reduction of mobile consumer devices has further allowed consumers to both access and post media content on the go. For example, web enabled mobile terminals such as cellular phones and PDAs allow consumers to view Internet content such as YouTube videos and online blogs or to listen to audio files in a variety of popular formats from virtually any location on their portable device.

Thus, the line between content-provider and content-consumer has blurred and there are now more content-providers and more channels for distributing and accessing content than ever before and consumers may access digital content from virtually any location at any time. Moreover, the variety of modes of digital content access allows for content consumers to choose a mode of content access that best suits their current location and activity. For example, a content consumer actively engaged in jogging or driving a car may prefer to listen to audio content, such as a podcast, on a portable device. A content consumer using a personal computer terminal may prefer to access a web page and read text-based content such as that on a blog. On the other hand, a content consumer waiting at a busy airport terminal and having only a mobile terminal such as a PDA or cellular phone with a small display screen on which it is not easy to read web page text but which still enables the display of video content may wish to view multimedia video content.

However, content-providers still face great difficulty in producing and distributing content if they wish to make their content available in multiple formats across different media content distribution channels so as to best accommodate various user scenarios such as those described above. For example, if a blogger wishes to make the contents of his written blog available as an audio file so that a content consumer can listen to the blog over a portable digital media player and/or as a video file so that a content consumer could view the blog content using a variety of video playback devices, the blogger would have to manually read out and record all texts to convert them to audio or video media.

Even existing text to speech (TTS) conversion programs do not solve this dilemma as the simple TTS converters simply generate an audio version of the input text without taking into account any images, hyperlinks, or other data which may be embedded in the source file or any emotions which may be conveyed by the semantic structure of the content, such as images, a specific arrangement of the content, or effects and formatting applied to the source text. Thus a large part of the emotion and atmospherics intended to be conveyed by the blog may be lost in the translation when merely using conventional TTS programs and consequently user experience may be negatively impacted.

Accordingly, it would be advantageous to provide methods, apparatuses, and computer program products that allow for the automated conversion of text-based content, such as a blog viewable via a web browser, into either or both audio data that may be listened to and video data that may be viewed on a variety of devices while preserving the semantic structure of the content so as to maintain the intended user experience.

### BRIEF SUMMARY

A method, apparatus, and computer program product are therefore provided to improve the ease and efficiency with which source data containing text and/or other elements, such as web content, may be converted to audio and/or video content while preserving crucial elements of the intended user experience. In particular, a method, apparatus, and computer program product are provided to enable, for example, the conversion of source data to audio or video data which includes effects representative of the structure of the original source data. Accordingly, content creators may easily port their text-based content into other formats for distribution over multiple media channels while still maintaining intended elements of the user experience.

In one exemplary embodiment, a method is provided which may comprise parsing source data having one or more tags and creating a semantic structure model representative of the source data, and generating audio data comprising at least one of speech converted from parsed text of the source data contained in the semantic structure model and applied audio effects.

In another exemplary embodiment, a computer program product for generating digital media data from source data is provided. The computer program product includes at least one computer-readable storage medium having computer-readable program code portions stored therein. The computer-readable program code portions include first and second executable portions. The first executable portion is for parsing source data having one or more tags and creating a semantic structure model representative of the source data. The second executable portion is for generating audio data comprising at least one of speech converted from parsed text of the source data contained in the semantic structure model and applied audio effects.

In another exemplary embodiment, an apparatus for generating digital media data from source data is provided. The apparatus may include a processor. The processor may be configured to parse source data having text and one or more tags and create a semantic structure model representative of the source data and to generate audio data comprising at least one of speech converted from parsed text of the source data contained in the semantic structure model and applied audio effects.

Embodiments of the invention may therefore provide a method, apparatus, and computer program product for generating digital media data from source data. As a result, for example, content creators and consumers may benefit from the expedited porting of source data, such as web-based content, to alternative audio and video formats for distribution over alternative media distribution channels while still preserving intended elements of the user experience in the ported files.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an exemplary implementation for converting source data to digital media data;

FIG. 4 is a flowchart according to an exemplary method for converting source data to digital media data; and

FIG. 5 illustrates images of a sample conversion from a web page to a series of scenes.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

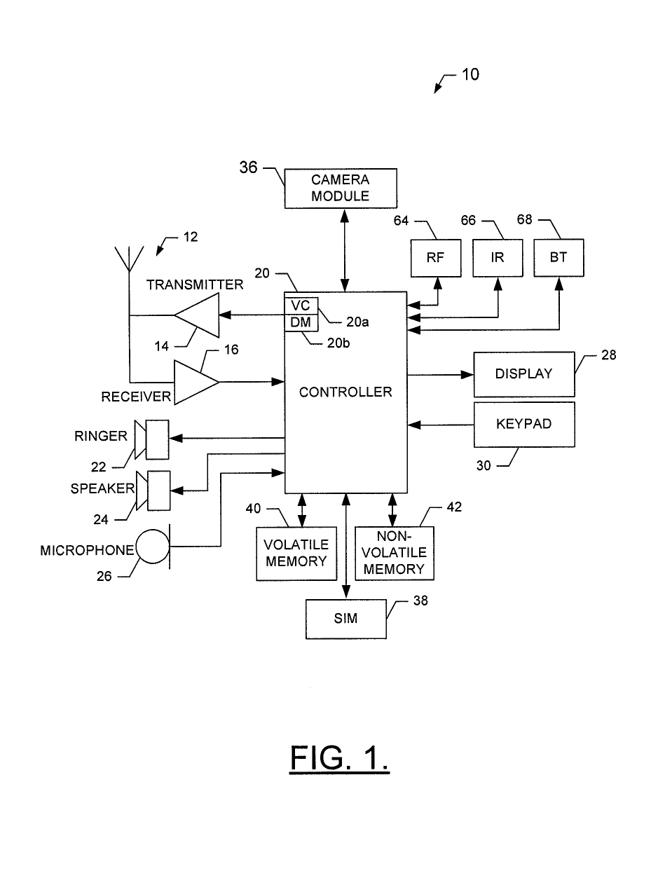

FIG. 1 illustrates a block diagram of a mobile terminal 10 that may benefit from the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ the present invention.

As shown, the mobile terminal 10 includes an antenna 12 in communication with a transmitter 14, and a receiver 16. The mobile terminal also includes a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as UMTS network employing WCDMA radio access technology. Some NAMPS, as well as TACS, mobile terminals may also benefit from the teaching of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 36, the camera module 36 may include a digital camera capable of forming a digital image file from a captured image or a digital video file from a series of captured images. As such, the camera module 36 includes all hardware, such as a lens or other optical device, and software necessary for creating a digital image or video file from a captured image or series of captured images. Alternatively, the camera module 36 may include only the hardware needed to view an image, while a memory device of the mobile terminal 10 stores instructions for execution by the controller 20 in the form of software necessary to create a digital image or video file from a captured image or images. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode, for example according to a JPEG or MPEG standard format.

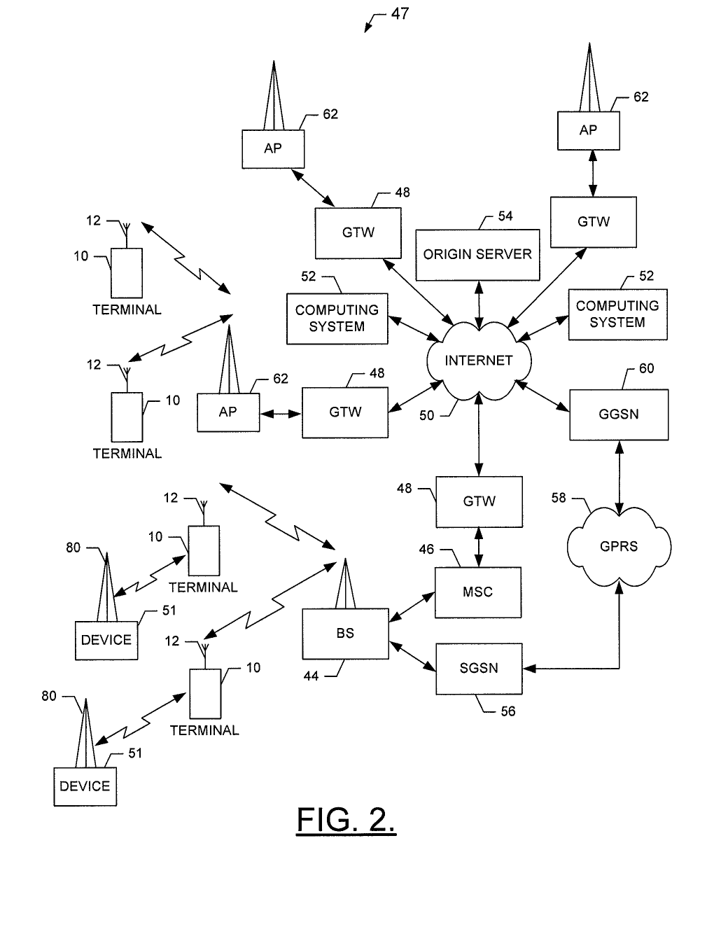

Referring now to FIG. 2, an illustration of one type of system that could support communications to and from an electronic device, such as the mobile terminal of FIG. 1, is provided by way of example, but not of limitation. As shown, one or more mobile terminals 10 may each include an antenna 12 for transmitting signals to and for receiving signals from a base site or base station (BS) 44. The base station 44 may be a part of one or more cellular or mobile networks each of which may comprise elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or origin server 54 across the Internet 50, the mobile terminal 10, computing system 52 and origin server 54 may be coupled to one another and communicate in accordance with, for example, RF, BT, IrDA or any of a number of different wireline or wireless communication techniques, including LAN, WLAN, WiMAX, Wireless Fidelity (Wi-Fi), Wibree™ and/or UWB techniques. One or more of the computing systems 52 may additionally, or alternatively, include a removable memory capable of storing content, which can thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 can comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

In an exemplary embodiment, content or data may be communicated over the system of FIG. 2 between a mobile terminal, which may be similar to the mobile terminal 10 of FIG. 1 and a network device of the system of FIG. 2 in order to execute applications for establishing communication between the mobile terminal 10 and other mobile terminals, for example, via the system of FIG. 2. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a network device such as a server or other device accessible to the communication device.

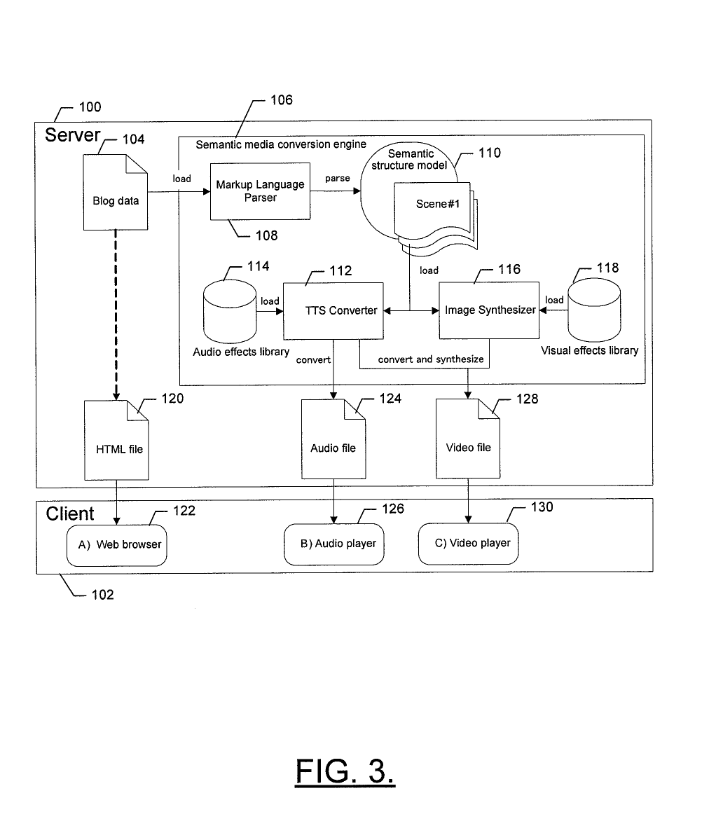

FIG. 3 illustrates a block diagram of a system for converting a source file to a digital media file according to an exemplary embodiment of the present invention. As used herein, the term “exemplary” merely refers to an example. For purposes of this description, the invention will be described using blog data formatted using Hypertext Markup Language (HTML) as an example initial source file. However, it will be appreciated by one skilled in the art that embodiments of the current invention are not limited to source files containing blog data, but may also operate on other types of data, such as source files formatted in tagged markup languages other than HTML, such as Scribe, GML, SGML, XML, XHTML, LaTeX, and/or the like.

The system of FIG. 3 will be described, for purposes of example, in connection with the mobile terminal 10 of FIG. 1 and various elements of the system of FIG. 2. However, it should be appreciated that the system depicted in the block diagram of FIG. 3 may be embodied in devices and communications networks other than those depicted in FIGS. 1 and 2. The system of FIG. 3 includes a server 100, which may be embodied as, for example, the origin server 54 in the system of FIG. 2, and a client 102, which may be embodied as, for example, a mobile terminal 10 or a computing system 52 of the system of FIG. 2.

The client 102 may include a web browser 122, which may be embodied in any device or means embodied in either hardware, software, or a combination of hardware and software. The web browser 122 may be controlled by or embodied as the processor, for example, the controller 20 of the mobile terminal 10. The web browser 122 may be configured to allow the display of a source file, such as HTML file 120 over a display screen, such as the display 28 of the mobile terminal 10, in communication with the client 102. A user may be able to interact with the displayed HTML file 120 such as by activating hyperlinks to other web pages or multimedia files through various input means, such as the keypad 30 of the mobile terminal 10.

The client 102 may comprise an audio player 126, which may be embodied in any device or means embodied in either hardware, software, or a combination of hardware and software. The audio player 126 may be controlled by or embodied as the processor, for example, the controller 20 of the mobile terminal 10. The audio player 126 may be configured to allow the playback of an audio file, such as audio file 124. The audio file 124 may be formatted in any of several digital audio formats, such as WAV, MP3, VORBIS, WMA, AAC, and/or the like which may be supported by the audio player 126. A user playing back audio file 124 using audio player 126 on the client 102 may listen to the audio content of the audio file 124 over any speaker in communication with the client 102, such as the speaker 24 of the mobile terminal 10.

The client 102 may comprise a video player 130, which may be embodied in any device or means embodied in either hardware, software, or a combination of hardware and software. The video player 130 may be controlled by or embodied as the processor, such as, the controller 20 of the mobile terminal 10. The video player 130 may be configured to allow the playback of a video file, such as video file 128. The video file 128 may be formatted in any of several digital video formats, such as any of the MPEG standards, AVI, WMV, and/or the like which may be supported by the video player 130. A user playing back the video file 128 using the video player 130 on the client 102 may view video content of the video file 128 over any display associated with the client 102, such as the display 28 of the mobile terminal 10. A user playing back the video file 128 using the video player 130 on the client 102 may listen to audio content contained in the video file 128 over any speaker associated with the client 102, such as the speaker 24 of the mobile terminal 10.

The server 100 may contain a memory, which is not shown. The memory may comprise volatile memory and/or non-volatile memory. The memory may store source data, which may comprise blog data 104. The server 100 may be configured to retrieve the source data such as the blog data 104 from a remote device in communication with the server 100, such as any of the devices of the system of FIG. 2. This retrieving may be related to a request by a user of the server 100 or other network device, such as any of the devices of the system of FIG. 2. In an exemplary embodiment, the server 100 may transmit the blog data 104 as an HTML file 120 for display on the web browser 122 of the client 102 without any modification, as the source file of this example includes blog data 104, which is pre-formatted in HTML.

The server 100 may further comprise a semantic media conversion engine 106, which allows for the generation of an audio file 124 and/or a video file 128 from source data such as the blog data 104. In an exemplary embodiment in which the source data contains an HTML file, the semantic media conversion engine 106 may contain a markup language parser (“parser”) 108, which may be, for example an HTML parser. The parser 108 may be embodied in any device or means embodied in either hardware, software, or a combination of hardware and software. Execution of the parser 108 may be controlled by or embodied as a processor. The parser 108 may be configured to load source data in HTML format, such as the blog data 104 and to parse the source data to generate a semantic structure model 110 representing the blog data 104, which may contain information parsed from the HTML structure by the parser 108. The information contained in the semantic structure model 110 may comprise the position(s) of tagged words and other elements, the source(s) of image(s) associated with a paragraph, scene information generated from the parsed results, and/or the like. This information may be used to define various aspects of the subsequently generated audio file 124 and/or video file 128 such as the number of characters in a paragraph.

The semantic media conversion engine 106 may further contain a TTS converter 112. The TTS converter 112 may be embodied in any device or means embodied in either hardware, software, or a combination of hardware and software. Execution of the TTS converter 112 may be controlled by or otherwise embodied as a processor. The TTS converter 112 may comprise an algorithm, commercially available software modules, and/or the like for generating audio data based at least in part on input text data. The TTS converter 112 may determine appropriate audio effects to add to the audio data generated from converting the text data to speech. It may be desirable to use audio effects to help provide a similar user experience as would be had by viewing the original source blog data 104. The audio effects to be added by the TTS converter 112 may be determined by any number of means.

In an exemplary embodiment, audio effects may be based at least in part on tag information, such as HTML tags, used to format the text, which may include for example having a short pause in the audio playback of the converted text data following an HTML tag for a line break, having the converted audio data be played back louder over portions of text encased in HTML tags which serve to bold or emphasize words, inserting an introduction of linked pages at the tail end of the audio if there are hyperlinks to other HTML pages contained within the source blog data 104, and/or the like. In another exemplary embodiment, audio effects may be based at least in part on special word pairings or on special HTML tags embedded within the source blog data 104 that serve a purpose other than to format the text. For example, the TTS converter 112 may determine to add an audio effect of a dog barking in response to reading a word pairing within the semantic structure model 110 such as “barking dog” or in response to special HTML tags such as <bark></bark> created for the purpose of adding audio effects to the converted file. In another exemplary embodiment, audio effects may be based at least in part on special character combinations embedded within the text extracted from the blog data 104 by the parser 108 and contained within the semantic structure model 110. Examples of such special character combinations include what are known as emoticons, or smiley faces, such as “;)” or “:).” In response to encountering such a character combination a laughing voice audio effect may be added to the audio data generated by the TTS converter 112. It will be appreciated, however, that the above examples are merely a few examples of means for determining from the data contained within the semantic structure model 110 whether to and what audio effects to add to the converted audio data and that the invention is not limited to just these example scenarios. Moreover, the term “tags” as used herein should be construed not just to include tags used in a markup language, but to include any similar means or device used to designate data formatting or special effects which should be added upon semantic conversion to audio and/or video data.

The audio effects library 114 may comprise audio which may be added to the converted audio data by the TTS converter 112. According to an exemplary embodiment, the audio effects library 114 may be a repository of audio clips and effects stored in a memory. The memory on which the audio effects library 114 is stored may be memory local to the server 100 or may be remote memory of one or more other devices, for example any device of the system of FIG. 2.

Once the TTS converter 112 has converted all of the text of the semantic structure model 110 to speech and added appropriate audio effects from the audio effects library 114, the TTS converter 112 may generate an audio file 124 comprised of the generated audio data containing converted text and added audio effects. The audio file 124 may be in any of a number of formats which may be playable on a digital audio player such as the audio player 126 of client 102. Additionally, or alternatively, if a video file is to be generated, the TTS converter 112 may pass the generated audio data to an image synthesizer 116.

The image synthesizer 116 may be embodied in any device or means embodied in either hardware, software, or a combination of hardware and software. Execution of the image synthesizer 116 may be controlled by or otherwise embodied as a processor. In an exemplary embodiment, the image synthesizer 116 may be configured to create a slide show by correlating video data synthesized by the image synthesizer 116 with the converted audio data generated by the TTS converter 112 to generate a video file 128. The image synthesizer 116 may be configured to load the semantic structure model 110 as well as appropriate visual effects from a visual effects library 118 to be added to the synthesized video data. According to an exemplary embodiment, the visual effects library 118 is a repository of visual effects stored in a memory. The memory on which the visual effects library 118 is stored may be memory local to the server 100 or may be remote memory of any of the devices of the system of FIG. 2.

In synthesizing visual data from the semantic structure model 110, the image synthesizer 116 may determine appropriate visual effects to add based on the tags, such as HTML tag mappings. A goal of the added visual effects is to reconstruct a similar experience to what a user would have if he viewed the original blog data 104 through the use of visual data. For example, a separate slide, or scene, of video data may be created for each paragraph of text data in the semantic structure model 110 as denoted by a paragraph or line break tag and an additional visual effect of fading out to switch the scene between slides may be added in response to the HTML tag. In a further example, if text data is encased in tags which serve to bold or emphasize words then a visual shaking effect may be added to the synthesized video data during the audio playback of that speech. If an image is in the original blog data 104 as indicated by an image tag then it may be displayed on the slide during which the adjacent text, as determined by the semantic structure model 110, is read back via the converted audio data. Further, if the blog data contains a link to another web page, a visual effect of a thumbnail image of the linked page may be displayed on the slide while the audio data reading the sentence or text grouping containing the link is played. It will be appreciated, however, that the above examples are merely a few examples of means for determining from the data contained within the semantic structure model 110 whether to and what visual effects to add to the converted video data and that the invention is not limited to just these example scenarios. Moreover, the term “tags” as used herein should be construed not just to include tags used in a markup language, but to include any similar means or device used to designate data formatting or special effects which should be added upon semantic conversion to audio and/or video data.

Once the image synthesizer 116 has generated video data containing appropriate visual effects as determined from the semantic structure model 110, the video data may be correlated along with the converted audio data to create a video file 128. The video file 128 may be in any of a number of formats playable on a digital video player such as the video player 130 of the client 102.

Although the above description of the system of FIG. 3 has discussed generating audio and video files using initial source data formatted in HTML, it will be appreciated that the invention may be applied to any tagged text or other tagged source data, such as a tagged markup language and that the parser 108 may be substituted with a parser designed to interpret a different type of tagged source file, such as a source file formatted in an alternative tagged markup language and to generate a semantic structure model 110 from the alternatively tagged source file. Furthermore, the TTS converter 112 and image synthesizer 116 may be configured to determine appropriate audio and visual effects using tags native to another source file format. Alternatively, any parser 108 used in the system may contain specifications to transcode the tags of the source file regardless of the format of the file to a specified tag notation recognized by the TTS converter 112 and image synthesizer 116 when generating the semantic structure model 110.

It will be further appreciated that while the above discussion of one embodiment of the invention as depicted in FIG. 3 describes creating a digital media file from the converted audio data and synthesized video data, embodiments of the invention are not limited to the creation of a media file from the converted audio data and/or the synthesized video data. In alternative embodiments, a device may generate converted audio data and then stream the converted audio data to a remote device, such as any device of the system of FIG. 2 over a network link without creating an audio file. Also, in alternative embodiments a device may correlate converted audio data along with synthesized video data to generate correlated video data and then stream the correlated video data to a remote device, such as any device of the system of FIG. 2 over a network link.

Furthermore, while the block diagram of FIG. 3 and the above discussion discusses the actual conversion of source data to audio and/or video data taking place on a server before delivery to a client device, it will be appreciated that embodiments of the invention are not limited to such a configuration. In an alternative embodiment, the hardware, software, or combination of hardware and software may reside on the client 102 and the actual conversion may take place on the client device.

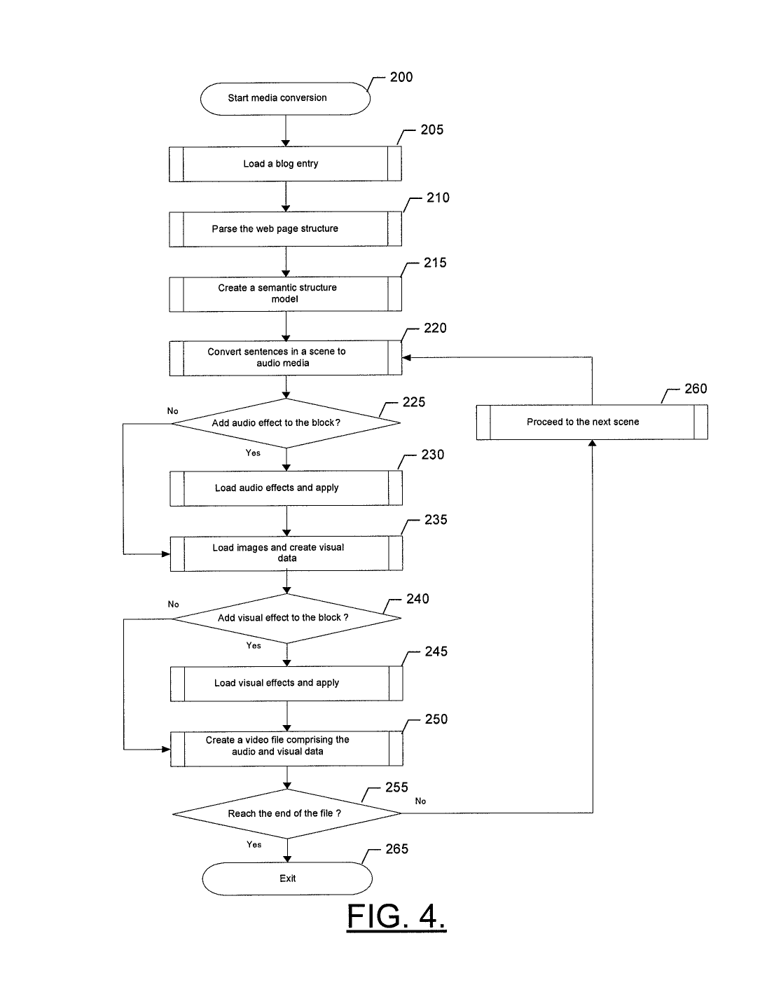

FIG. 4 is a flowchart of a method and computer program product according to an exemplary embodiment of the invention. It will be understood that each block or step of the flowchart, and combinations of blocks in the flowchart may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computing device or other programmable apparatus (e.g., hardware) to produce a machine, such that the instructions which execute on the computing device or other programmable apparatus create means for implementing the functions specified in the flowchart block(s) or step(s). These computer program instructions may also be stored in a computer-readable memory that may direct a computing device or other programmable apparatus to function in a particular manner, such that the instructions stored in the computer-readable memory produce an article of manufacture including instruction means which implement the function specified in the flowchart block(s) or step(s). The computer program instructions may be loaded onto a computing device or other programmable apparatus to cause a series of operational steps to be performed on the computing device or other programmable apparatus to produce a computer-implemented process such that the instructions which execute on the computing device or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer instructions.

In this regard, one embodiment of a method of converting source data to a digital media file as depicted in FIG. 4 may include initializing the media conversion process 200. Next, at operation 205, a blog entry may be loaded for conversion. Again, while a blog entry is discussed for purposes of example, embodiments of the invention are not limited to operation on blog data, nor are they limited to only source data formatted in HTML. Next, the web page structure may be parsed 210 for purposes of creating a semantic structure model 215. As previously described, the semantic structure model may comprise the relative positioning of elements in the original source file, relevant tags used to generate audio and/or video effects, as well as information used for purposes of converting the audio data and/or synthesizing the video data to divide the converted output data into logical sections herein referred to as scenes. Each scene may be comprised, for example, of the data in a single paragraph of text, section, or other logical division, of the source file and include any embedded images, links, or other data within the logical division.

Operation 220 may comprise converting sentences in a scene to audio media. While the embodiment of FIG. 4 depicts only converting one scene of text at a time to audio media, in an alternative embodiment all scenes of text may be converted to audio media at once. Next, at operation 225 the TTS converter may determine whether to add an audio effect to the block based on information contained in the semantic structure model as described above in the discussion of FIG. 3. If one or more audio effects are to be added to the block then at operation 230 the audio effects may be loaded from the audio effects library and applied. If audio effects are not to be added to the block, then operation 230 may be skipped.

Operations 235-245 are optional blocks, which may be performed if a video file is being synthesized. If only an audio file is being synthesized then these operations may be skipped. At operation 235, images parsed into the semantic structure model may be loaded and visual data may be created. Next, at the decisional block of operation 240, the image synthesizer may determine whether to add one or more visual effects to the block. If the TTS converter determines that one or more visual effects should be added to the block, then at operation 245 the appropriate visual effect(s) may be loaded from the visual effects library and applied. If, on the other hand, the TTS converter determines that no visual effects should be added to the block, operation 245 may be skipped. At operation 250, a video file comprising the audio and visual data may be created. Note, however, that additionally or in the alternative an audio file comprising the audio data may be created if an audio file is a desired output. Also, as discussed previously, embodiments of the invention are not limited to the creation of a media file. In alternative embodiments, the invention may create digital media content from source data and then stream that digital media content to a remote device. Operation 255 is a decisional block wherein it may be determined if the end of the file has been reached. If the end of the file has not been reached, then operation 260 is to proceed to the next scene and the method may return to operation 220. Note, however, that as described above in an alternative embodiment operation 220 may comprise converting all sentences in the semantic structure model to audio media at once and so proceeding to the next scene at operation 260 may instead comprise returning to operation 225 and determining whether to add an audio effect to the next block. Once the end of the file has been reached, operation 265 is to exit and the final audio and/or video file is completed.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

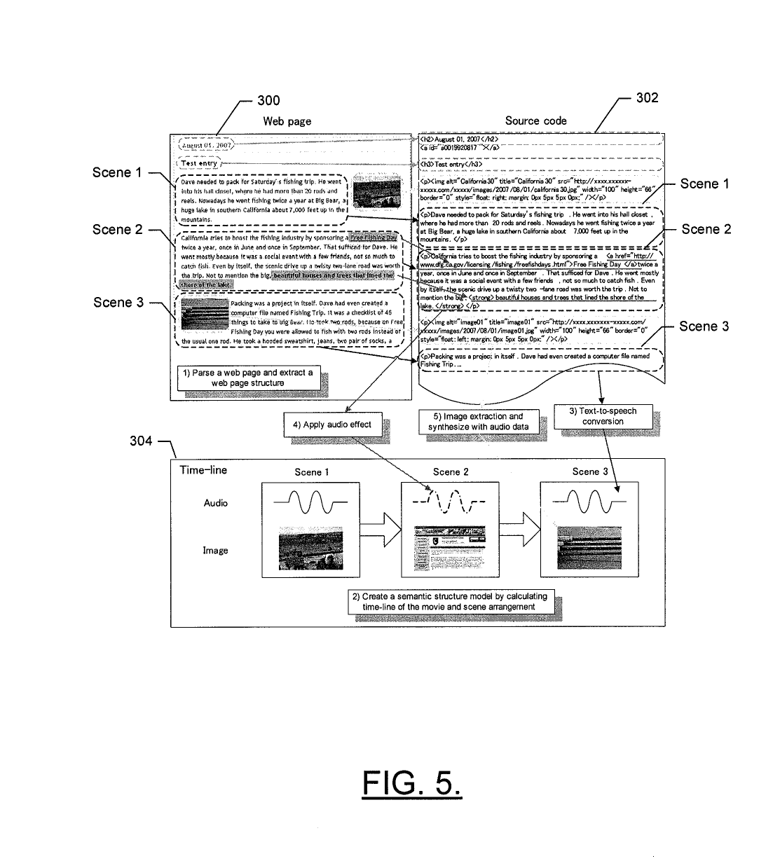

FIG. 5 depicts images of a sample web page 300, its constituent source code 302, and a timeline of scenes 304 which may result from its semantic conversion to a video file. Referring to the original web page 300, the first scene may comprise the first paragraph of text as well as the image to its right, which the parser may determine should be part of the first scene due to its positioning relative to the adjacent text. The second scene may comprise the second paragraph of text, which includes an embedded hyperlink and a line of text that is emphasized due to its enclosure in <strong></strong> HTML tags as seen in the source code 302. Finally, the third scene may comprise the third paragraph of text as well as the image around which the paragraph of text is wrapped. Now referring to the timeline of scenes 304, Scene 1 depicts the image determined to be part of Scene 1 due to its positioning relative to the text. Scene 1 may also contain audio data converted from the text of the first paragraph. Scene 2 may display a thumbnail image of the webpage linked in the link embedded in the text of the second paragraph. The audio data of Scene 2 may contain not only the speech converted from the text, but also an applied audio effect of speaking louder when verbalizing the emphasized text contained within the <strong></strong> tags. Finally, Scene 3 may be comprised of the extracted image and audio data representing the text converted to speech.

As such, then, embodiments of the invention provide several advantages for conversion of a source file such as a web page to audio and/or video files for distribution over multiple media distribution channels such as the system depicted in FIG. 2. A content creator or even a content consumer may easily convert source files, such as web-based content, to audio and/or video files for optimum playback on multiple devices in multiple user scenarios without losing any elements of the intended user experience that a user would experience by interacting with the original source file. Thus, embodiments of the invention allow content creators and consumers to easily take advantage of the multitude of media distribution channels and portable devices in existence without requiring a content creator to take the time to manually create or convert media to multiple forms for distribution.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
parsing source data having one or more tags and creating a semantic structure model representative of the source data; and
generating audio data comprising at least one of speech converted from parsed text of the source data contained in the semantic structure model and applied audio effects.

2. A method according to claim 1 further comprising generating video data based at least in part on at least one of images extracted from the source data, images extracted from linked web pages, and applied visual effects and correlating the video data with the audio data.

3. A method according to claim 1, wherein the source data comprises blog data.

4. A method according to claim 1, wherein generating audio data comprises retrieving the applied audio effects from an audio effects library based at least in part on at least one of tag mapping, key words within the source data, and key character combinations within the source data.

5. A method according to claim 2, wherein generating video data comprises retrieving the applied visual effects from a visual effects library based at least in part on tag mapping.

6. A method according to claim 1, wherein creating the semantic structure model comprises creating a semantic structure model that is a representation of the parsed source data containing at least one of a positioning of one or more elements, one or more tags, and scene information.

7. A method according to claim 1, further comprising creating a digital media file comprising the audio data.

8. A method according to claim 2, further comprising creating a digital media file comprising the correlated audio and video data.

9. A computer program product comprising at least one computer-readable storage medium having computer-readable program code portions stored therein, the computer-readable program code portions comprising:
a first executable portion for parsing source data having text and one or more tags and creating a semantic structure model representative of the source data; and
a second executable portion for generating audio data comprising at least one of speech converted from parsed text of the source data contained in the semantic structure model and applied audio effects.

10. A computer program product according to claim 9 further comprising a third executable portion for generating video data based at least in part on at least one of images extracted the source data, images extracted from linked web pages, and applied visual effects and correlating the video data with the audio data.

11. A computer program product according to claim 9, wherein the second executable portion includes instructions for retrieving the applied audio effects from an audio effects library based at least in part on at least one of tag mapping, key words within the source data, and key character combinations within the source data.

12. A computer program product according to claim 10, wherein the third executable portion includes instructions for retrieving the applied visual effects from a visual effects library based at least in part on tag mapping.

13. A computer program product according to claim 9, wherein the semantic structure model is a representation of the parsed source data containing at least one of a positioning of one or more elements, one or more tags, and scene information.

14. A computer program product according to claim 9, further comprising a third executable portion for creating a digital media file comprising the audio data.

15. A computer program product according to claim 10 further comprising a fourth executable portion for creating a digital media file comprising the correlated audio and video data.

16. An apparatus comprising a processor configured to:
parse source data having text and one or more tags and create a semantic structure model representative of the source data; and
generate audio data comprising at least one of speech converted from parsed text of the source data contained in the semantic structure model and applied audio effects.

17. An apparatus according to claim 16, wherein the processor is further configured to generate video data based at least in part on at least one of images extracted from the source data, images extracted from linked web pages, and applied visual effects and to correlate the video data with the audio data.

18. An apparatus according to claim 16, wherein the source data comprises blog data.

19. An apparatus according to claim 16, wherein the processor is further configured to retrieve the applied audio effects from an audio effects library based at least in part on at least one of tag mapping, key words within the source data, and key character combinations within the source data.

20. An apparatus according to claim 17, wherein the processor is further configured to retrieve the applied visual effects from a visual effects library based at least in part on tag mapping.

21. An apparatus according to claim 16, wherein the processor is further configured to create the semantic structure model as a representation of the parsed source data containing at least one of a positioning of one or more elements, one or more tags, and scene information.

22. An apparatus according to claim 16, wherein the processor is further configured to create a ditital media file comprising the audio data.

23. An apparatus according to claim 17, wherein the processor is further configured to create a digital media file comprising the correlated audio and video data.

24. An apparatus comprising:
means for parsing source data having text and one or more tags and creating a semantic structure model representative of the source data; and
means for generating audio data comprising at least one of speech converted from parsed text of the source data contained in the semantic structure model and applied audio effects.

25. An apparatus according to claim 22, further comprising:
means for generating video data based at least in part on at least one of images extracted from the source data, images extracted from linked web pages, and applied visual effects.
